(19) United States
(12) Patent Application Publication
(10) Pub. No.: US 2024/0064769 A1
(43) Pub. Date: Feb. 22, 2024

(54) INFORMATION TRANSMISSION METHOD AND DEVICE

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/269,394

(22) PCT Filed: Dec. 26, 2020
(86) PCT No.: PCT/CN2020/139724

§ 371 Date: Jun. 23, 2023

(51) Int. Cl. H04W 72/232; H04W 72/12

(52) U.S. Cl. CPC H04W 72/232; H04W 72/12

(57) ABSTRACT

An information transmission method, includes: performing multi-transmission time interval (TTI) scheduling by means of target downlink control information (DCI), sending first indication information which is used for indicating a target scheduling mode corresponding to the target DCI, where the target scheduling mode includes a first multi-TTI scheduling mode for scheduling two or more identical transport blocks, or the target scheduling mode includes a second multi-TTI scheduling mode for scheduling two or more different transport blocks.

### CROSS REFERENCE TO RELATED APPLICATION

The present application is a U.S. National Stage of International Application No. PCT/CN2020/139724, filed on Dec. 26, 2020, the contents of all of which are incorporated herein by reference in their entireties for all purposes.

### BACKGROUND

In data scheduling, in order to ensure scheduling flexibility, one piece of downlink control information (DCI) may only schedule one physical downlink shared channel (PDSCH) or schedule one physical uplink shared channel (PUSCH).

### SUMMARY

The disclosure relates to the field of communication, in particular to an information transmission method and device.

Examples of the disclosure provide an information transmission method and device.

According to a first aspect of the example of the disclosure, an information transmission method is provided and performed by a base station, including:
performing multi-transmission time interval (TTI) scheduling through target downlink control information (DCI), sending first indication information which is used for indicating a target scheduling mode corresponding to the target DCI, where the target scheduling mode includes a first multi-TTI scheduling mode for scheduling two or more than two identical transport blocks, or,
the target scheduling mode includes a second multi-TTI scheduling mode for scheduling two or more than two different transport blocks.

According to a second aspect of the example of the disclosure, an information transmission method is provided and performed by a terminal, including:
receiving target downlink control information (DCI) which is used for performing multi-transmission time interval (TTI) scheduling, determining a target scheduling mode corresponding to the target DCI, where the target scheduling mode includes a first multi-TTI scheduling mode for scheduling two or more than two identical transport blocks, or,
the target scheduling mode includes a second multi-TTI scheduling mode for scheduling two or more than two different transport blocks.

According to a third aspect of the example of the disclosure, an electronic device is provided, including:
a processor; and
a memory, configured to store processor executable instructions, where
the processor is configured to execute the information transmission method described in any item of the first aspect.

It needs to be understood that the above general descriptions and later detailed descriptions are merely examples and illustrative, and cannot limit the disclosure.

### BRIEF DESCRIPTION OF THE DRAWINGS

The accompanying drawings here are incorporated into the specification and constitute a part of the specification, showing the principles consistent with the examples of the disclosure and used together with the specification to explain the disclosure.

FIG. 1 is a schematic diagram of a multi-TTI scheduling scenario illustrated according to an example.

FIG. 2 is a schematic flowchart of an information transmission method illustrated according to an example.

FIG. 3 is a schematic flowchart of another information transmission method illustrated according to an example.

FIG. 4 is a schematic flowchart of another information transmission method illustrated according to an example.

FIG. 5 is a schematic flowchart of another information transmission method illustrated according to an example.

FIG. 6 is a schematic flowchart of another information transmission method illustrated according to an example.

FIG. 7 is a schematic flowchart of another information transmission method illustrated according to an example.

FIG. 8 is a schematic flowchart of another information transmission method illustrated according to an example.

FIG. 9 is a schematic flowchart of another information transmission method illustrated according to an example.

FIG. 10 is a schematic flowchart of another information transmission method illustrated according to an example.

FIG. 11 is a schematic flowchart of another information transmission method illustrated according to an example.

FIG. 12 is a schematic flowchart of another information transmission method illustrated according to an example.

FIG. 13 is a schematic flowchart of another information transmission method illustrated according to an example.

FIG. 14 is a schematic flowchart of another information transmission method illustrated according to an example.

FIG. 15 is a schematic flowchart of another information transmission method illustrated according to an example.

FIG. 16 is a schematic flowchart of another information transmission method illustrated according to an example.

FIG. 17 is a schematic flowchart of another information transmission method illustrated according to an example.

FIG. 18 is a schematic flowchart of another information transmission method illustrated according to an example.

FIG. 19 is a schematic flowchart of another information transmission method illustrated according to an example.

FIG. 20 is a schematic flowchart of another information transmission method illustrated according to an example.

FIG. 21 is a block diagram of an information transmission apparatus illustrated according to an example.

FIG. 22 is a block diagram of another information transmission apparatus illustrated according to an example.

FIG. 23 is a schematic structural diagram of an information transmission apparatus illustrated according to an example.

FIG. 24 is a schematic structural diagram of another information transmission apparatus illustrated according to an example.

### DETAILED DESCRIPTION

Examples will be described in detail here, and instances are shown in the accompanying drawings. When the following description refers to the accompanying drawings, unless otherwise indicated, the same numbers in different accompanying drawings indicate the same or similar elements. The implementations described in the following examples do not represent all implementations consistent with the disclosure. Rather, they are merely instances of apparatuses and methods consistent with some aspects of the disclosure as detailed in the appended claims.

The terms used in the disclosure are merely for the purpose of describing specific examples, and not intended to limit the disclosure. The singular forms “one,” “said,” and “the” used in the disclosure and the appended claims are also intended to include plural forms unless the context clearly indicates other meanings. It needs also to be understood that the term “and/or” as used here refers to and includes any or all possible combinations of one or more associated listed items.

It needs to be understood that although the terms first, second, third, etc., may be used to describe various information in the disclosure, such information is limited to these terms. These terms are merely used to distinguish the same type of information from each other. For example, without departing from the scope of the disclosure, first information may also be referred to as second information, and similarly, the second information may also be referred to as the first information. Depending on the context, the word “if” as used here can be interpreted as “at the time,” “when,” or “in response to determining.”

In a new radio (NR) system, multi-TTI scheduling is proposed, that is, PDSCHs of a plurality of slots or PUSCHs of the plurality of slots are scheduled by one piece of DCI, so that the quantity of the DCI is reduced, and a complexity of blind detection of the DCI by UE is reduced. The PDSCH or PUSCH of multi-TTI scheduling may be used for repeated transmission of data or transmitting different downlink data respectively.

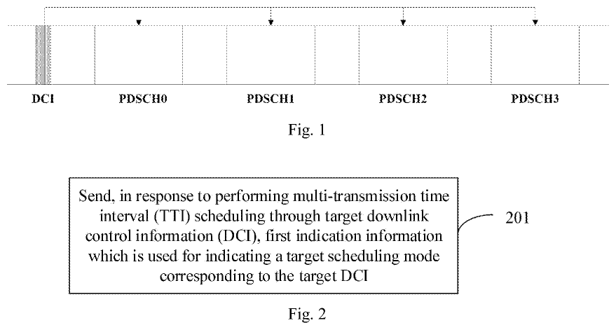

A scenario of multi-TTI scheduling is as shown in FIG. 1, where 4 PDSCHs may be scheduled through one piece of DCI. The 4 PDSCHs belong to different slots. FIG. 1 shows a situation that the slots where the 4 PDSCHs are located are adjacent. It needs to be illustrated that, it is not ruled out that the slots where each PDSCH is located are not adjacent. For example, every 2 PDSCHs are separated by 2 or more slots.

FIG. 1 merely takes a situation that a plurality of PDSCHs are scheduled through one piece of DCI as an example, and in practical applications, a plurality of PUSCHs being scheduled through one piece of DCI also falls within a scope of the multi-TTI scheduling.

In a case that multi-TTI scheduling is used for scheduling a plurality of identical transport blocks (TBs), enhanced coverage may be realized, which may be used for both uplink and downlink transmission. As for the case that the multi-TTI scheduling is used for scheduling the plurality of identical TBs, the plurality of scheduled PDSCHs or PUSCHs may use identical hybrid automatic repeat request (HARQ) identifiers, taking scheduling the plurality of PDSCHs as an example, and after a terminal may merge and demodulate, one piece of HARQ information is fed back.

In a case that the multi-TTI scheduling is used for scheduling a plurality of different TBs, it may be used for reducing the number of the DCI, and the complexity of blind detection of the terminal is reduced. Since modulation coding schemes (MC S s) used by the PDSCH or PUSCH scheduled in a plurality of TTIs are usually the same, the number of once scheduling of the TTI is also related to the speed of channel changes. If the channel changes quickly, in order to ensure that the MCS matches the channel, the number of once scheduling of the TTI may be small, and merely one TTI may be scheduled. If the channel changes slowly, the number of the TTIs that may be scheduled may be large.

As for the case that the multi-TTI scheduling is used for scheduling the plurality of different TBs, each scheduled PDSCH or PUSCH may have different HARQ identifiers, and taking scheduling the plurality of PDSCHs as an example, the terminal needs to feed back the HARQ information of each PDSCH.

In order to enable the terminal to distinguish whether a certain piece of DCI schedules the plurality of identical TBs or the plurality of different TBs in multi-TTI scheduling, the following information transmission method is provided by the disclosure.

The information transmission method provided by the example of the disclosure is introduced firstly from a base station side below.

The example of the disclosure provides an information transmission method, which may be applied to a base station. Referring to FIG. 2, FIG. 2 is a flowchart of an information transmission method illustrated according to an example, and the method may include the following steps:
in step 201, in response to performing multi-transmission time interval (TTI) scheduling through target downlink control information (DCI), first indication information which is used for indicating a target scheduling mode corresponding to the target DCI is sent.

In the example of the disclosure, the target DCI is DCI for performing multi-TTI scheduling, and PDSCHs or PUSCHs of a plurality of slots may be scheduled through the target DCI. The target scheduling mode includes a first multi-TTI scheduling mode for scheduling two or more than two identical transport blocks, or the target scheduling mode includes a second multi-TTI scheduling mode for scheduling two or more than two different transport blocks.

In the above example, the base station may send the first indication information in a case that multi-TTI scheduling is performed through the target DCI, so that the terminal determines the target scheduling mode corresponding to the target DCI. The target scheduling mode may include the first multi-TTI scheduling mode for scheduling two or more than two identical transport blocks, or the target scheduling mode may also include the second multi-TTI scheduling mode for scheduling two or more than two different transport blocks. In multi-TTI scheduling, the purpose of scheduling a plurality of identical or different transport blocks through the target DCI is realized, and the flexibility of multi-TTI scheduling is improved.

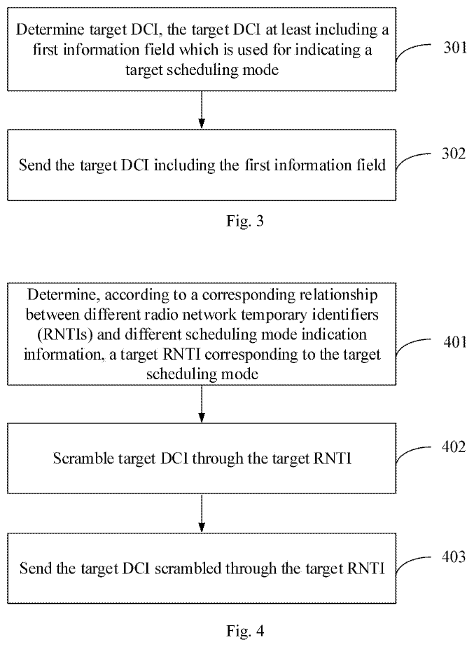

In some optional examples, referring to FIG. 3, FIG. 3 is a flowchart of another information transmission method illustrated according to an example, and the method may include the following steps:
in step 301, target DCI is determined, and the target DCI at least includes a first information field which is used for indicating a target scheduling mode.

In the example of the disclosure, the target DCI for performing multi-TTI scheduling may at least include the first information field, and the first information field may be an information field used for indicating the target scheduling mode corresponding to the target DCI. In the example of the disclosure, above step 301 may be applied to a scenario where multi-transmission time interval (TTI) scheduling is performed through the target downlink control information (DCI), or any other appropriate scenarios.

In an example, the first information field may occupy 1 bit. A bit value of the first information field, when being a first preset value, is used for indicating that the target scheduling mode is the first multi-TTI scheduling mode, and the bit value of the first information field, when being a second preset value, is used for indicating that the target scheduling mode is the second multi-TTI scheduling mode. The second preset value is different from the first preset value.

For example, the bit value of the first information field is set as 0, which correspondingly indicates that the target scheduling mode is the first multi-TTI scheduling mode, that is, the plurality of identical TBs are scheduled by the target DCI. The bit value of the first information field is set as 1, which correspondingly indicates that the target scheduling mode is the second multi-TTI scheduling mode, that is, the plurality of different TBs are scheduled by the target DCI. Vice versa.

In step 302, the target DCI including the first information field is sent.

In the example of the disclosure, the base station may send the target DCI including the first information field, and the terminal may determine the target scheduling mode corresponding to the target DCI according to indication of the first information field.

In the above example, the base station may generate the target DCI including the first information field which is used for indicating the target scheduling mode, so that the terminal determines the target scheduling mode corresponding to the target DCI according to the indication of the first information field, the flexibility of multi-TTI scheduling is improved, and meanwhile signaling resources are saved.

In some optional examples, referring to FIG. 4, FIG. 4 is a flowchart of another information transmission method illustrated according to an example, and the method may include the following steps:
in step 401, according to a corresponding relationship between different radio network temporary identifiers (RNTIs) and different scheduling mode indication information, a target RNTI corresponding to a target scheduling mode is determined.

In the example of the disclosure, above step 401 may be applied to a scenario where multi-transmission time interval (TTI) scheduling is performed through target downlink control information (DCI), or any other appropriate scenarios. In an example, RNTI-1 corresponds to first scheduling mode indication information, RNTI-2 corresponds to second scheduling mode indication information, the first scheduling mode indication information is used for indicating a first multi-TTI scheduling mode, and the second scheduling mode indication information is used for indicating a second multi-TTI scheduling mode. The base station may determine the corresponding target RNTI according to the target scheduling mode.

In step 402, the target DCI is scrambled through the target RNTI.

In step 403, the target DCI scrambled through the target RNTI is sent.

In the example of the disclosure, the base station may send the target DCI scrambled through the target RNTI, and the terminal determines the target scheduling mode corresponding to the target DCI after scrambling by the target RNTI.

In the above example, the base station may scramble the target DCI through different RNTIs, so that the terminal determines the target scheduling mode corresponding to the target DCI through the target RNTI scrambling the target DCI, the flexibility of multi-TTI scheduling is improved, and meanwhile the signaling resources are saved.

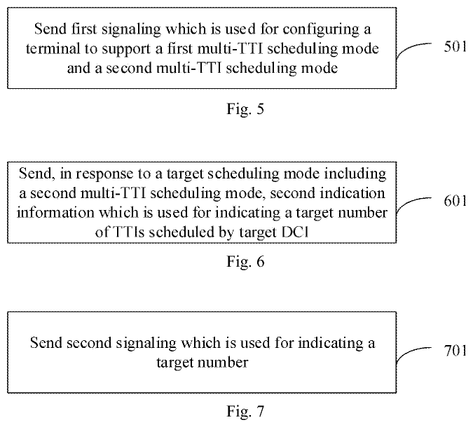

In some optional examples, referring to FIG. 5, FIG. 5 is a flowchart of another information transmission method illustrated according to an example, and the method may include the following steps:
in step 501, first signaling which is used for configuring a terminal to support a first multi-TTI scheduling mode and a second multi-TTI scheduling mode is sent.

In the example of the disclosure, above step 501 may be applied to a scenario where multi-transmission time interval (TTI) scheduling is performed through target downlink control information (DCI), or any other appropriate scenarios.

In the example of the disclosure, the base station needs to support the first multi-TTI scheduling mode and the second multi-TTI scheduling mode, and correspondingly, a terminal side also needs to support the two scheduling modes. The base station may configure the terminal to support the above two scheduling modes through first signaling. The first signaling includes, but is not limited to high-level signaling, and the high-level signaling may include, but is not limited to radio resource control (RRC) signaling, and media access control address (MAC) signaling.

In the above example, the base station may configure the terminal to support the first multi-TTI scheduling mode and the second multi-TTI scheduling mode through the first signaling. On the basis of the terminal supporting the above two scheduling modes, a plurality of identical or different TBs may be scheduled through the target DCI, and the flexibility of multi-TTI scheduling is improved.

In some optional examples, referring to FIG. 6, FIG. 6 is a flowchart of another information transmission method illustrated according to an example, and the method may include the following steps:
in step 601, in response to a target scheduling mode including a second multi-TTI scheduling mode, second indication information which is used for indicating a target number of TTIs scheduled by target DCI is sent.

In the example of the disclosure, the base station may determine that the target scheduling mode includes the second multi-TTI scheduling mode, that is, in a case that the plurality of different TBs are scheduled by the target DCI, the second indication information is sent, and the terminal may determine a target number of TTIs where different TBs scheduled by the target DCI are located based on the second indication information.

In the above example, the base station may send the second indication information in a case that it is determined that the target scheduling mode includes the second multi-TTI scheduling mode, and the terminal may determine the target number of the TTIs scheduled by the target DCI based on the second indication information, so that the terminal may perform HARQ feedback subsequently. The flexibility of multi-TTI scheduling is improved.

In some optional examples, referring to FIG. 7, FIG. 7 is a flowchart of another information transmission method illustrated according to an example, and the method may include the following steps:
in step 701, second signaling which is used for indicating a target number is sent.

In the example of the disclosure, the second signaling includes, but is not limited to high-level signaling, and the high-level signaling includes, but is not limited to RRC signaling and MAC signaling.

In the above example, the base station may directly send the target number of the TTIs scheduled by the target DCI through the second signaling, implementation is easy, and usability is high.

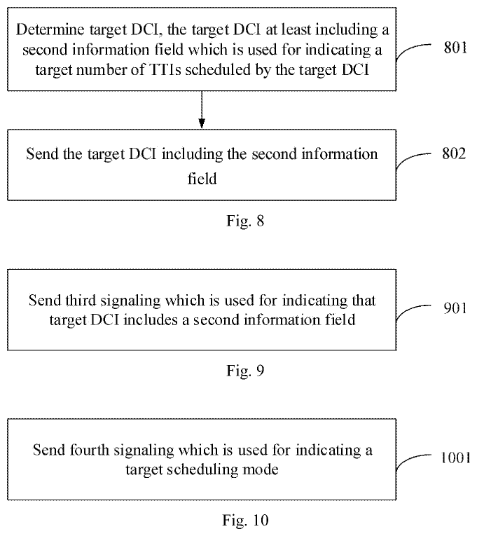

In some optional examples, referring to FIG. 8, FIG. 8 is a flowchart of another information transmission method illustrated according to an example, and the method may include the following steps:
in step 801, target DCI is determined, and the target DCI at least includes a second information field which is used for indicating a target number of TTIs scheduled by the target DCI.

In the example of the disclosure, the second information field may be an information field which is used for indicating the target number of the TTIs scheduled by the target DCI.

In step 802, the target DCI including the second information field is sent.

In the above example, the base station may send the target DCI including the second information field in a case that the target scheduling mode includes the second multi-TTI scheduling mode, and the terminal may determine the target number of the TTIs scheduled by the target DCI based on the second information field. The flexibility of multi-TTI scheduling is improved.

In some optional examples, the base station may determine a bit value of the second information field added into the target DCI directly based on the target number of the TTIs scheduled by the target DCI. Optionally, the bit value of the second information field may be set as a numerical value corresponding to the target number.

For example, the number of the TTIs scheduled by the target DCI is 4, and the bit value of the second information field may be 100.

In the above example, the base station may determine the bit value of the second information field directly based on the target number, the implementation is easy, and the usability is high.

In some optional examples, a corresponding relationship between different numerical values and different scheduling item information may be solidified through predefined settings, such as protocol agreement, where the scheduling item information refers to at least one piece of information related to scheduling, and each piece of scheduling item information at least includes the number of the TTIs scheduled by multi-TTI scheduling. Of course, each piece of scheduling item information may further include other information related to scheduling, which is not limited in the disclosure.

Optionally, the corresponding relationship between the different numerical values and the different scheduling item information may be represented in a table, as shown in Table 1.

TABLE 1

| | Scheduling item information | | | |
|---|---|---|---|---|
| Numerical | Number of | Other scheduling | Other scheduling | |
| value | TTI | information 1 | information 2 | . . . |
| 1 | n1 | Information 11 | Information 21 | . . . |
| 2 | n2 | Information 12 | Information 22 | . . . |
| . . . | . . . | . . . | . . . | . . . |

In Table 1, the number of the TTI may be a positive integer. Table 1 is merely an example explanation. Those skilled in the art may understand that each item of the scheduling item information in Table 1 may be separately used as the content of the protocol agreement.

The base station may determine target scheduling item information including the target number of the TTIs scheduled by the target DCI according to Table 1. Further, the base station may determine a target numerical value corresponding to the target scheduling item information according to Table 1. Thus, based on the target numerical value, the bit value of the second information field is determined.

For example, the target number is 4, the number of the TTIs included in scheduling item information 2 in Table 1 is 4, a numerical value corresponding to the scheduling item information 2 is 2, and then the bit value of the second information field may be set as 10.

In the above example, the base station may indicate the target scheduling item information through the second information field, the terminal may take the number of the TTIs included in the target scheduling item information as the target number, so as to reduce a length of the second information field in the DCI, and the usability is high.

In some optional examples, referring to FIG. 9, FIG. 9 is a flowchart of another information transmission method illustrated according to an example, and the method may include the following steps:
in step 901, third signaling which is used for indicating that target DCI includes a second information field is sent.

In the example of the disclosure, the base station may send the third signaling, and the third signaling is used for indicating that the base station includes the second information field in the target DCI. The third signaling includes, but is not limited to the RRC signaling.

In the above example, the base station may dynamically adjust a length of the target DCI, in a case that the second information field is added into the target DCI, the terminal may be notified through the third signaling, DCI resources are effectively utilized, and the usability is high.

In some optional examples, referring to FIG. 10, FIG. 10 is a flowchart of another information transmission method illustrated according to an example, and the method may include the following steps:
in step 1001, fourth signaling which is used for indicating a target scheduling mode is sent.

In the example of the disclosure, the fourth signaling includes, but is not limited to high-level signaling, and the high-level signaling includes, but is not limited to RRC signaling and MAC signaling.

In the above example, the base station may directly send the target scheduling mode corresponding to the target DCI through the fourth signaling, in multi-TTI scheduling, the purpose of scheduling the plurality of identical or different transport blocks through the target DCI is realized, and the flexibility of multi-TTI scheduling is improved.

The information transmission method provided by the example of the disclosure is introduced then from a terminal side below.

The example of the disclosure provides an information transmission method, which may be applied to a terminal. Referring to FIG. 11, FIG. 11 is a flowchart of an information transmission method illustrated according to an example, and the method may include the following steps:
in step 1101, in response to receiving target downlink control information (DCI) which is used for performing multi-transmission time interval (TTI) scheduling, a target scheduling mode corresponding to the target DCI is determined.

In the example of the disclosure, the target scheduling mode includes a first multi-TTI scheduling mode for scheduling two or more than two identical transport blocks, or the target scheduling mode includes a second multi-TTI scheduling mode for scheduling two or more than two different transport blocks.

In the above example, the terminal may determine the target scheduling mode corresponding to the target DCI after receiving the target DCI, and the flexibility of multi-TTI scheduling is improved.

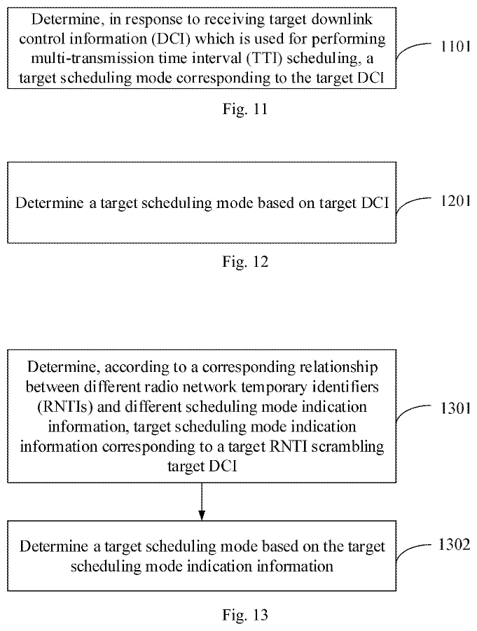

In some optional examples, referring to FIG. 12, FIG. 12 is a flowchart of an information transmission method illustrated according to an example, and the method may include the following steps:
in step 1201, a target scheduling mode is determined based on target DCI.

In the above example, the terminal may determine the target scheduling mode corresponding to the target DCI directly based on the target DCI, implementation is easy, and usability is high.

In some optional examples, the terminal may determine the target scheduling mode according to indication of a first information field in the target DCI. The first information field may be an information field which is used for indicating the target scheduling mode.

In the above example, the terminal determines the target scheduling mode corresponding to the target DCI directly according to the first information field which is used for indicating the target scheduling mode in the target DCI, and the flexibility of multi-TTI scheduling is improved.

In some optional examples, referring to FIG. 13, FIG. 13 is a flowchart of an information transmission method illustrated according to an example, and the method may include the following steps:
in step 1301, according to a corresponding relationship between different radio network temporary identifiers (RNTIs) and different scheduling mode indication information, target scheduling mode indication information corresponding to the target RNTI scrambling target DCI is determined.

In the example of the disclosure, the terminal may determine the target scheduling mode indication information corresponding to the target RNTI scrambling the target DCI by pre-determining the corresponding relationship between the different radio network temporary identifiers (RNTIs) and the different scheduling mode indication information.

In step 1302, a target scheduling mode is determined based on the target scheduling mode indication information.

In the above example, the terminal may determine the target scheduling mode corresponding to the target DCI through the target RNTI scrambling the target DCI, the flexibility of multi-TTI scheduling is improved, DCI signaling resources are saved, and the usability is high.

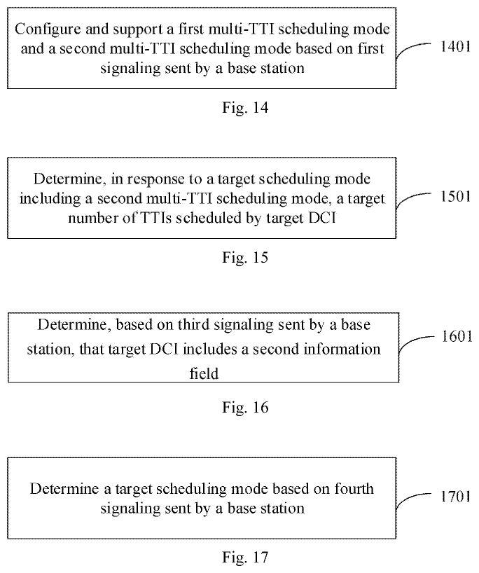

In some optional examples, referring to FIG. 14, FIG. 14 is a flowchart of an information transmission method illustrated according to an example, and the method may include the following steps:
in step 1401, a first multi-TTI scheduling mode and a second multi-TTI scheduling mode are configured and supported based on first signaling sent by a base station.

In the example of the disclosure, a terminal may configure the first multi-TTI scheduling mode and the second multi-TTI scheduling mode which are supported by itself according to the first signaling sent by the base station. Subsequently, the terminal may determine that the target scheduling mode corresponding to the target DCI is one of the above two modes according to the target DCI.

In the above example, the terminal may configure and support the above first multi-TTI scheduling mode and the second multi-TTI scheduling mode according to signaling indication of the base station, and the flexibility of multi-TTI scheduling is improved.

In some optional examples, referring to FIG. 15, FIG. 15 is a flowchart of an information transmission method illustrated according to an example, and the method may include the following steps:
in step 1501, in response to a target scheduling mode including a second multi-TTI scheduling mode, a target number of TTIs scheduled by target DCI is determined.

In the example of the disclosure, the terminal may determine the target number of the TTIs scheduled by the target DCI in a case that it is determined that the target scheduling mode includes the second multi-TTI scheduling mode, so that HARQ feedback is performed for each TTI subsequently.

In the above example, the terminal may determine the target number of the TTIs scheduled by the target DCI as for a situation that the base station schedules a plurality of different TBs through the target DCI, and the usability is high.

In some optional examples, the terminal may determine the target number of the TTIs scheduled by the target DCI directly according to second signaling sent by the base station, the second signaling includes, but is not limited to high-level signaling, and the high-level signaling includes, but is not limited to RRC signaling and MAC signaling.

In the above example, in a case that the target scheduling mode includes the second multi-TTI scheduling mode, the terminal may determine the target number of the TTIs scheduled by the target DCI according to indication of the second signaling sent by the base station, the implementation is easy, and the usability is high.

In some optional examples, the terminal may determine the target number according to a second information field in the target DCI.

In an example, the terminal directly takes a number indicated by a bit value of the second information field as the target number.

For example, the bit value of the second information field is 100, the indicated number is 4, then the terminal determines that the target DCI schedules a plurality of different TBs, and the number of the scheduled TTIs is 4.

In another example, the terminal may determine the target number according to the target numerical value indicated by the bit value of the second information field, and the corresponding relationship between different numerical values and different scheduling item information.

In the example of the disclosure, the corresponding relationship between the above different numerical values and different scheduling item information is solidified through the agreement, and optionally, the corresponding relationship between the different numerical values and the different scheduling item information may be represented in Table 1.

The terminal determines the bit value of the second information field is 10, the indicated target numerical value is 2, it may be determined that the numerical value 2 corresponds to the scheduling item information 2 through Table 1, the number of the TTI included in the scheduling item information 2 is 4, and then the terminal may determine that the number of the TTIs scheduled by the target DCI is 4. In the above example, in a case that the target scheduling mode includes the second multi-TTI scheduling mode, the terminal may determine the number of the TTIs scheduled by the target DCI through the corresponding relationship between the different numerical values and the different scheduling item information, and the numerical value indicated by the second information field in the target DCI, the flexibility of multi-TTI scheduling is improved, meanwhile the target number may be determined through the small bit value of the second information field in the target DCI, and the signaling resources are saved.

In some optional examples, referring to FIG. 16, FIG. 16 is a flowchart of an information transmission method illustrated according to an example, and the method may include the following steps:
in step 1601, based on third signaling sent by a base station, it is determined that target DCI includes a second information field.

In the example of the disclosure, the third signaling includes, but is not limited to RRC signaling. The terminal determines that the target DCI includes the second information field according to the third signaling, and further, the terminal may determine the target number of the TTIs scheduled by the target DCI according to the second information field.

In the above example, in a case that the target scheduling mode includes the second multi-TTI scheduling mode, the terminal may determine that the target DCI includes the second information field according to indication of the third signaling sent by the base station, so that the target number of the TTIs scheduled by the target DCI is determined based on the second information field, the implementation is easy, and the usability is high.

In some optional examples, referring to FIG. 17, FIG. 17 is a flowchart of an information transmission method illustrated according to an example, and the method may include the following steps:

In step 1701, a target scheduling mode is determined based on fourth signaling sent by a base station.

In the example of the disclosure, the fourth signaling includes, but is not limited to high-level signaling, and the high-level signaling includes, but is not limited to RRC signaling and MAC signaling.

In the above example, the terminal may directly determine the target scheduling mode corresponding to the target DCI based on the high-level signaling sent by the base station. The flexibility of multi-TTI scheduling is improved, and the usability is high.

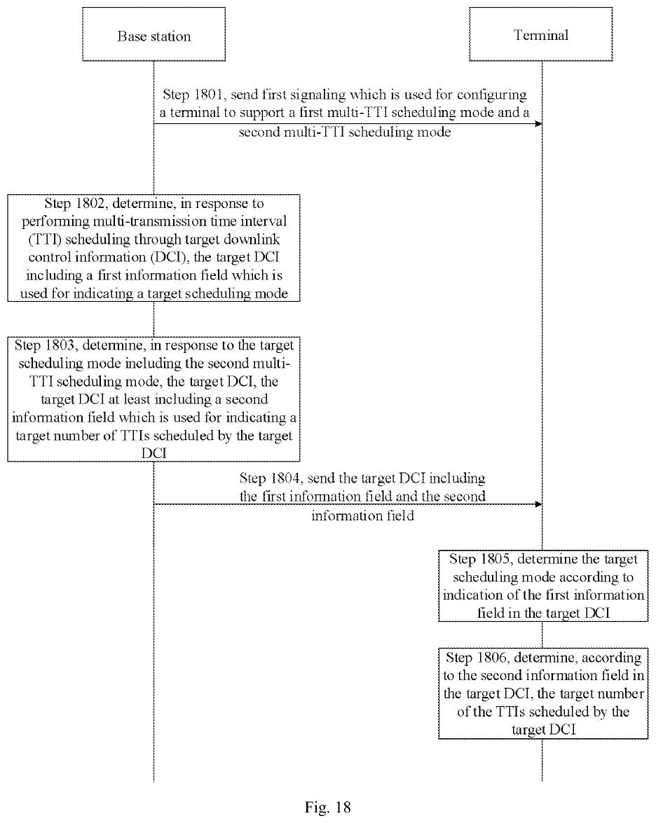

In some optional examples, referring to FIG. 18, FIG. 18 is a flowchart of an information transmission method illustrated according to an example, and the method may include the following steps:
in step 1801, a base station sends first signaling which is used for configuring a terminal to support a first multi-TTI scheduling mode and a second multi-TTI scheduling mode.

In the example of the disclosure, the base station configures the terminal to support the two multi-TTI scheduling modes through the first signaling. The first multi-TTI scheduling mode is used for scheduling a plurality of identical transport blocks, and the second multi-TTI scheduling mode is used for scheduling a plurality of different transport blocks.

In step 1802, in response to determining that multi-transmission time interval (TTI) scheduling needs to be performed through target downlink control information (DCI), the base station determines the target DCI including a first information field which is used for indicating a target scheduling mode.

The target scheduling mode includes the first multi-TTI scheduling mode or the second multi-TTI scheduling mode.

In step 1803, in response to the target scheduling mode including the second multi-TTI scheduling mode, the base station determines the target DCI, and the target DCI at least includes a second information field which is used for indicating a target number of TTIs scheduled by the target DCI.

In step 1804, the base station sends the target DCI including the first information field and the second information field.

In step 1805, the terminal determines the target scheduling mode according to indication of the first information field in the target DCI.

In step 1806, the terminal determines the target number of the TTIs scheduled by the target DCI according to the second information field in the target DCI.

In the above example, the base station may send the target scheduling mode corresponding to the target DCI and the number of the TTIs scheduled by the target DCI to the terminal directly through the target DCI, there is no need to use other signaling to notify the terminal, the signaling resources are saved, the purpose of scheduling the plurality of identical or different transport blocks through the target DCI is realized, and the flexibility of multi-TTI scheduling is improved.

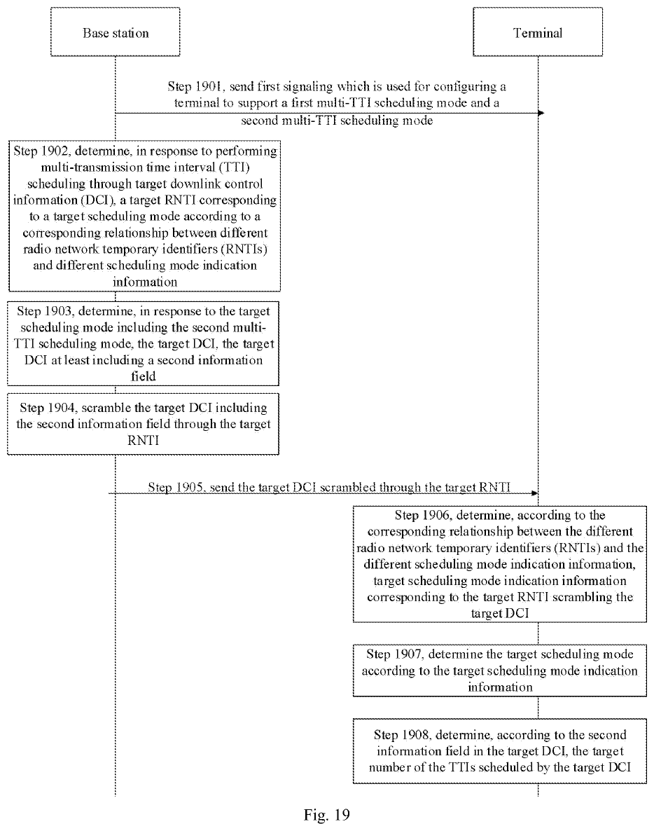

In some optional examples, referring to FIG. 19, FIG. 19 is a flowchart of an information transmission method illustrated according to an example, and the method may include the following steps:
in step 1901, a base station sends first signaling which is used for configuring a terminal to support a first multi-TTI scheduling mode and a second multi-TTI scheduling mode.

In the example of the disclosure, the base station configures the terminal to support the two multi-TTI scheduling modes through the first signaling. The first multi-TTI scheduling mode is used for scheduling a plurality of identical transport blocks, and the second multi-TTI scheduling mode is used for scheduling a plurality of different transport blocks.

In step 1902, in response to performing multi-transmission time interval (TTI) scheduling through target downlink control information (DCI), the base station determines a target RNTI corresponding to a target scheduling mode according to a corresponding relationship between different radio network temporary identifiers (RNTIs) and different scheduling mode indication information.

The target scheduling mode is a scheduling mode corresponding to the target DCI, and includes the first multi-TTI scheduling mode or the second multi-TTI scheduling mode.

In step 1903, in response to the target scheduling mode including the second multi-TTI scheduling mode, the base station determines the target DCI, and the target DCI at least includes a second information field.

In step 1904, the target DCI including the second information field is scrambled through the target RNTI.

In step 1905, the base station sends the target DCI scrambled through the target RNTI.

In step 1906, according to a corresponding relationship between different radio network temporary identifiers (RNTIs) and different scheduling mode indication information, the terminal determines target scheduling mode indication information corresponding to the target RNTI scrambling the target DCI.

In step 1907, the terminal determines the target scheduling mode according to the target scheduling mode indication information.

In step 1908, the terminal determines the target number of the TTIs scheduled by the target DCI according to the second information field in the target DCI.

In the above example, the base station may send the target scheduling mode corresponding to the target DCI to the terminal through the target RNTI scrambling the target DCI, and DCI resources are saved. In addition, the base station may send the number of the TTIs scheduled by the target DCI to the terminal through the target DCI. The purpose of scheduling a plurality of identical or different transport blocks through the target DCI is realized, and the flexibility of multi-TTI scheduling is improved.

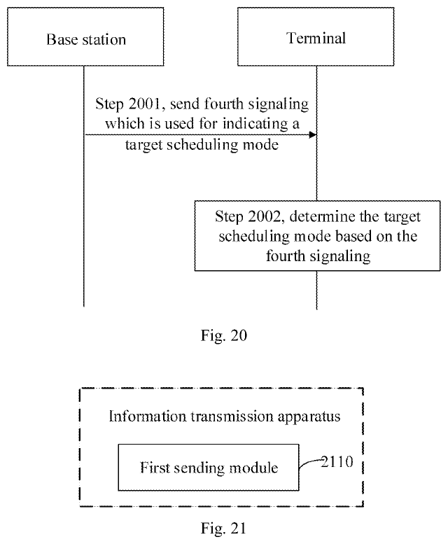

In some optional examples, referring to FIG. 20, FIG. 20 is a flowchart of an information transmission method illustrated according to an example, and the method may include the following steps:
in step 2001, a base station sends fourth signaling which is used for indicating a target scheduling mode.

In step 2002, a terminal determines the target scheduling mode based on the fourth signaling.

In a case that the target scheduling mode includes a second multi-TTI scheduling mode, the base station may include a second information field in target DCI, and send the target number of the TTIs scheduled by the target DCI to the terminal through the second information field, and the mode for determining the target number by the terminal is the same as that provided in the above examples, which will not be repeated here.

The technical solution provided by the examples of the disclosure may include the following beneficial effects:

In the examples of the disclosure, the base station may send the first indication information in a case that multi-TTI scheduling needs to be performed through the target DCI, so that the terminal determines the target scheduling mode corresponding to the target DCI. The target scheduling mode may include the first multi-TTI scheduling mode for scheduling two or more than two identical transport blocks, or the target scheduling mode may include the second multi-TTI scheduling mode for scheduling two or more than two different transport blocks. In multi-TTI scheduling, the purpose of scheduling a plurality of identical or different transport blocks through the target DCI is realized, and the flexibility of multi-TTI scheduling is improved.

In the examples of the disclosure, the base station may generate the target DCI including the first information field which is used for indicating the target scheduling mode, so that the terminal determines the target scheduling mode corresponding to the target DCI according to the indication of the first information field, the flexibility of multi-TTI scheduling is improved, and meanwhile signaling resources are saved.

In the examples of the disclosure, the base station may scramble the target DCI through different RNTIs, so that the terminal determines the target scheduling mode corresponding to the target DCI through the target RNTI scrambling the target DCI, the flexibility of multi-TTI scheduling is improved, and meanwhile the signaling resources are saved.

In the examples of the disclosure, the base station may send the second indication information in a case that it is determined that the target scheduling mode includes the second multi-TTI scheduling mode, and the terminal may determine the target number of the TTIs scheduled by the target DCI based on the second indication information, so that the terminal may perform HARQ feedback subsequently. The flexibility of multi-TTI scheduling is improved.

In the examples of the disclosure, the base station may send the target number of the TTIs scheduled by the target DCI through the second signaling, or the base station may also send the target number of the TTIs scheduled by the target DCI to the terminal by determining the target DCI including the second information field, implementation is easy, and availability is high.

In the examples of the disclosure, the base station may directly send the target scheduling mode corresponding to the target DCI through the fourth signaling, in multi-TTI scheduling, the purpose of scheduling a plurality of identical or different transport blocks through the target DCI is realized, and the flexibility of multi-TTI scheduling is improved.

In the above example, the base station may send the target scheduling mode corresponding to the target DCI to the terminal directly through a signaling mode, the purpose of scheduling the plurality of identical or different transport blocks through the target DCI is realized, and the flexibility of multi-TTI scheduling is improved.

Corresponding to the above examples of an application function implementation method, the disclosure further provides examples of an application function implementation apparatus.

Referring to FIG. 21, FIG. 21 is a block diagram of an information transmission apparatus illustrated according to an example, and the apparatus is applied to a base station, including:
a first sending module 2110, configured to send, in response to performing multi-transmission time interval (TTI) scheduling through target downlink control information (DCI), first indication information which is used for indicating a target scheduling mode corresponding to the target DCI to a terminal, where the target scheduling mode includes a first multi-TTI scheduling mode for scheduling two or more than two identical transport blocks, or,
the target scheduling mode includes a second multi-TTI scheduling mode for scheduling two or more than two different transport blocks.

Optionally, the apparatus further includes:
a first executing module, configured to determine the target DCI, where the target DCI at least includes a first information field which is used for indicating the target scheduling mode; and
the first sending module includes:
a first sending submodule, configured to send the target DCI including the first information field.

Optionally, the apparatus further includes:
a second determining module, configured to determine, according to a corresponding relationship between different radio network temporary identifiers (RNTIs) and different scheduling mode indication information, a target RNTI corresponding to the target scheduling mode; and
a scrambling module, configured to scramble the target DCI through the target RNTI.

The first sending module includes:
a second sending submodule, configured to send the target DCI scrambled through the target RNTI.

Optionally, the apparatus further includes:
a second sending module, configured to send first signaling which is used for configuring a terminal to support the first multi-TTI scheduling mode and the second multi-TTI scheduling mode.

Optionally, the apparatus further includes:
a third sending module, configured to send, in response to the target scheduling mode including the second multi-TTI scheduling mode, second indication information which is used for indicating a target number of TTIs scheduled by the target DCI.

Optionally, the third sending module includes:
a third sending submodule, configured to send second signaling which is used for indicating a target number.

Optionally, the apparatus further includes:
a second executing module, configured to determine the target DCI, where the target DCI at least includes a second information field which is used for indicating the target number of the TTIs scheduled by the target DCI.

The third sending module includes:
a fourth sending submodule, configured to send the target DCI including the second information field.

Optionally, the apparatus further includes:
a third determining module, configured to determine a bit value of the second information field based on the target number.

Optionally, the apparatus further includes:
a fourth determining module, configured to determine, based on a plurality of pieces of preset scheduling item information, target scheduling item information including the target number, where each piece of scheduling item information at least includes a number of TTIs scheduled by performing multi-TTI scheduling;
a fifth determining module, configured to determine, based on a corresponding relationship between different numerical values and different scheduling item information, a target numerical value corresponding to the target scheduling item information; and
a sixth determining module, configured to determine a bit value of the second information field based on the target numerical value.

Optionally, the apparatus further includes:
a fifth sending module, configured to send third signaling which is used for indicating that the target DCI includes the second information field.

Optionally, the first sending module includes:
a fifth sending submodule, configured to send fourth signaling which is used for indicating the target scheduling mode.

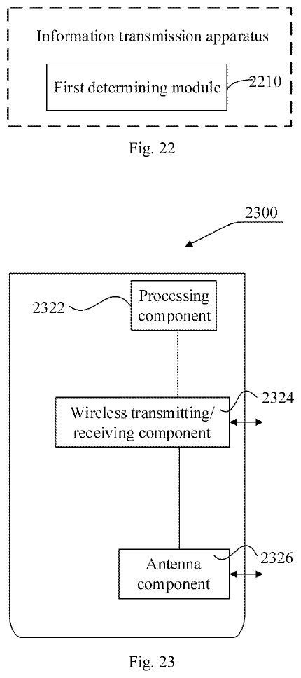

Referring to FIG. 22, FIG. 22 is a block diagram of an information transmission apparatus illustrated according to an example, and the apparatus is applied to a terminal, including:
a first determining module 2210, configured to determine, in response to receiving target downlink control information (DCI) which is used for performing multi-transmission time interval (TTI) scheduling, a target scheduling mode corresponding to the target DCI, where the target scheduling mode includes a first multi-TTI scheduling mode for scheduling two or more than two identical transport blocks, or,
the target scheduling mode includes a second multi-TTI scheduling mode for scheduling two or more than two different transport blocks.

Optionally, the first determining module includes:
a first determining submodule, configured to determine the target scheduling mode based on the target DCI.

Optionally, the first determining submodule includes:
a first determining unit, configured to determine the target scheduling mode based on indication of a first information field in the target DCI.

Optionally, the first determining submodule includes:
a second determining unit, configured to determine, according to a corresponding relationship between different radio network temporary identifiers (RNTIs) and different scheduling mode indication information, target scheduling mode indication information corresponding to a target RNTI scrambling the target DCI; and
a third determining unit, configured to determine the target scheduling mode based on the target scheduling mode indication information.

Optionally, the apparatus further includes:
a configuring module, configured to configure and support the first multi-TTI scheduling mode and the second multi-TTI scheduling mode based on first signaling sent by a base station.

Optionally, the apparatus further includes:
a seventh determining module, configured to determine, in response to the target scheduling mode including the second multi-TTI scheduling mode, a target number of TTIs scheduled by the target DCI.

Optionally, the seventh determining module includes:
a second determining submodule, configured to determine the target number based on second signaling sent by the base station.

Optionally, the second determining submodule includes:
a fourth determining unit, configured to determine the target number according to a second information field in the target DCI.

Optionally, the fourth determining unit includes:
a first determining subunit, configured to take a number indicated by a bit value of the second information field as the target number.

Optionally, the fourth determining unit includes:
a second determining subunit, configured to determine a target numerical value indicated by the bit value of the second information field;
a third determining subunit, configured to determine, according to a corresponding relationship between different numerical values and different scheduling item information, target scheduling item information corresponding to the target numerical value, where each piece of scheduling item information at least includes a number of TTIs scheduled by performing multi-TTI scheduling; and
a fourth determining subunit, configured to take a number of the TTIs included in the target scheduling item information as the target number.

Optionally, the apparatus further includes:
an eighth determining module, configured to determine, based on third signaling sent by the base station, that the target DCI includes the second information field.

Optionally, the first determining module includes:
a third determining submodule, configured to determine the target scheduling mode based on fourth signaling sent by the base station.

As for the apparatus examples, since it basically corresponds to the method examples, please refer to the partial description of the method examples for the relevant parts. The above apparatus examples are merely schematic, the above units described as separate components may be or may not be physically separated, and the components displayed as units may be or may not be physical units, that is, they may be located in one place, or may be distributed to multiple network units. Some or all of the modules may be selected according to actual needs to realize the purpose of the solution of the disclosure. Those of ordinary skill in the art may understand and implement it without creative labor.

Correspondingly, the disclosure further provides a computer readable storage medium, the storage medium stores a computer program, and the computer program is used for executing any information transmission method described on the base station side.

Correspondingly, the disclosure further provides a computer readable storage medium, the storage medium stores a computer program, and the computer program is used for executing any information transmission method described on the terminal side.

Correspondingly, the disclosure further provides an information transmission apparatus, including:
a processor; and
a memory, configured to store processor executable instructions.

The processor is configured to execute any information transmission method described on the base station side.

As shown in FIG. 23, FIG. 23 is a schematic structural diagram of another information transmission apparatus 2300 illustrated according to an example. The apparatus 2300 may be provided as a base station. Referring to FIG. 23, the apparatus 2300 includes a processing component 2322, a wireless transmitting/receiving component 2324, an antenna component 2326 and a signal processing part specific to a wireless interface, and the processing component 2322 may further include one or more processors.

A processor in the processing component 2322 may be configured to execute any information transmission method described on the above base station side.

Correspondingly, the disclosure further provides an information transmission apparatus, including:
a processor; and
a memory, configured to store processor executable instructions.

The processor is configured to execute any information transmission method described on the terminal side.

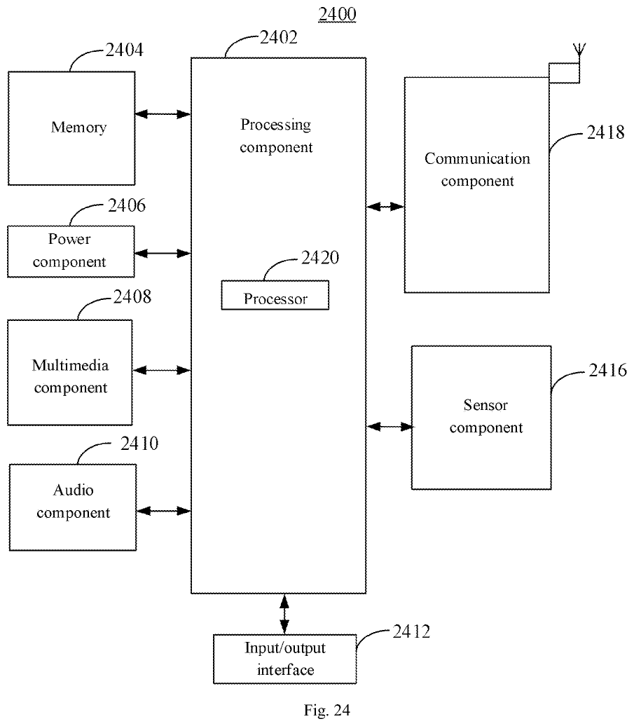

FIG. 24 is a block diagram of an electronic device 2400 illustrated according to an example. For example, the electronic device 2400 may be a mobile phone, a tablet, an e-book reader, a multimedia playback device, a wearable device, a vehicle-mounted terminal, an ipad, a smart TV and other terminals.

Referring to FIG. 24, the electronic device 2400 may include one or more of the following components: a processing component 2402, a memory 2404, a power component 2406, a multimedia component 2408, an audio component 2410, an input/output (I/O) interface 2412, a sensor component 2416, and a communication component 2418.

The processing component 2402 typically controls an overall operation of the electronic device 2400, such as operations associated with display, telephone call, data information transmission, camera operations, and recording operations. The processing component 2402 may include one or more processors 2420 to execute instructions to complete all or part of the steps of the above information transmission method. In addition, the processing component 2402 may include one or more modules to facilitate interaction between the processing component 2402 and other components. For example, the processing component 2402 may include a multimedia module to facilitate interaction between the multimedia component 2408 and the processing component 2402. For another example, the processing component 2402 may read an executable instruction from the memory to implement steps of an information transmission method provided by each above example.

The memory 2404 is configured to store various types of data to support operations at the electronic terminal 2400. Examples of these data include instructions for any application or method operating on the electronic device 2400, contact data, phonebook data, messages, pictures, videos, etc. The memory 2404 may be implemented by any type of volatile or nonvolatile storage device or their combination, such as a static random access memory (SRAM), an electrically erasable programmable read-only memory (EEPROM), an erasable programmable read-only memory (EPROM), a programmable read-only memory (PROM), a read-only memory (ROM), magnetic memory, a flash memory, a magnetic disk or an optical disk.

The power component 2406 provides power for various components of the electronic device 2400. The power component 2406 may include a power management system, one or more power sources and other components associated with generating, managing and distributing power for the electronic device 2400.

The multimedia component 2408 includes a display screen providing an output interface between the electronic device 2400 and a user. In some examples, the multimedia component 2408 includes a front camera and/or a rear camera. When the electronic device 2400 is in an operation mode, such as a shooting mode or a video mode, the front camera and/or the rear camera can receive external multimedia data. Each front camera and rear camera can be a fixed optical lens system or have a focal length and optical zoom capability.

The audio component 2410 is configured to output and/or input audio signals. For example, the audio component 2410 includes a microphone (MIC) configured to receive an external audio signal when the electronic device 2400 is in the operation mode, such as a call mode, a recording mode, and a speech recognition mode. The received audio signal may be further stored in the memory 2404 or transmitted via the communication component 2418. In some examples, the audio component 2410 further includes a speaker for outputting an audio signal.

The I/O interface 2412 provides an interface between the processing component 2402 and a peripheral interface module which may be a keyboard, a click wheel, a button, etc. These buttons may include, but not limited to: a home button, volume buttons, a start button and a lock button.

The sensor component 2416 includes one or more sensors for providing state evaluation of various aspects of the electronic device 2400. For example, the sensor component 2416 may detect an open/close state of the electronic device 2400 and relative positioning of the components, for example, the components are a display and a keypad of the electronic device 2400. The sensor component 2416 may further detect changes in a position of the electronic device 2400 or a component of the electronic device 2400, the presence or absence of contact between the user and the electronic device 2400, azimuth or acceleration/deceleration of the electronic device 2400, and temperature changes of the electronic device 2400. The sensor component 2416 may include a proximity sensor configured to detect the presence of nearby objects without any physical contact. The sensor component 2416 may further include an optical sensor, such as a CMOS or CCD image sensor, for use in imaging applications. In some examples, the sensor component 2416 may further include an acceleration sensor, a gyroscope sensor, a magnetic sensor, a pressure sensor, or a temperature sensor.

The communication component 2418 is configured to facilitate wired or wireless information transmission between the electronic device 2400 and other devices. The electronic device 2400 may access a wireless network based on an information transmission standard, such as Wi-Fi, 2G, 3G, 4G, 5G or 6G, or their combination. In an example, the communication component 2418 receives a broadcast signal or broadcast-related information from an external broadcast management system via a broadcast channel. In an example, the communication component 2418 further includes a near field information transmission (NFC) module to facilitate short-range communication. For example, the NFC module may be implemented based on a radio frequency identification (RFID) technology, an infrared data association (IrDA) technology, an ultra wideband (UWB) technology, a Bluetooth (BT) technology and other technologies.

In an example, the electronic device 2400 may be implemented by one or more application-specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic elements for executing the above information transmission method.

In an example, a non-transitory machine readable storage medium including instructions is further provided, such as the memory 2404 including instructions, which may be executed by the processor 2420 of the electronic device 2400 to complete the above information transmission method. For example, the non-transitory computer readable storage medium may be an ROM, a random access memory (RAM), a CD-ROM, a magnetic tape, a floppy disk, an optical data storage device, etc.

Embodiment 1. An information transmission method, applied to a base station and including:
sending, in response to performing multi-transmission time interval (TTI) scheduling through target downlink control information (DCI), first indication information used for indicating a target scheduling mode corresponding to the target DCI, wherein the target scheduling mode includes a first multi-TTI scheduling mode for scheduling two or more than two identical transport blocks, or,
the target scheduling mode includes a second multi-TTI scheduling mode for scheduling two or more than two different transport blocks.

Embodiment 2. The method according to embodiment 1, further including:
determining the target DCI, wherein the target DCI at least includes a first information field used for indicating the target scheduling mode; and
sending the first indication information used for indicating the target scheduling mode corresponding to the target DCI, includes:
sending the target DCI including the first information field.

Embodiment 3. The method according to embodiment 1, further including:
determining, according to a corresponding relationship between different radio network temporary identifiers (RNTIs) and different scheduling mode indication information, a target RNTI corresponding to the target scheduling mode; and
scrambling the target DCI through the target RNTI; and
sending the first indication information used for indicating the target scheduling mode corresponding to the target DCI, includes:
sending the target DCI scrambled through the target RNTI.

Embodiment 4. The method according to embodiment 2 or 3, wherein before sending the first indication information used for indicating the target scheduling mode corresponding to the target DCI, the method further includes:
sending first signaling used for configuring a terminal to support the first multi-TTI scheduling mode and the second multi-TTI scheduling mode.

Embodiment 5. The method according to embodiment 1, further including:
sending, in response to the target scheduling mode including the second multi-TTI scheduling mode, second indication information used for indicating a target number of TTIs scheduled by the target DCI.

Embodiment 6. The method according to embodiment 5, wherein sending the second indication information used for indicating the target number of TTIs scheduled by the target DCI, includes:
sending second signaling used for indicating the target number.

Embodiment 7. The method according to embodiment 5, further including:
determining the target DCI, wherein the target DCI at least includes a second information domain used for indicating the target number of the TTIs scheduled by the target DCI; and
sending the second indication information used for indicating the target number of the TTIs scheduled by the target DCI, includes:
sending the target DCI including the second information domain.

Embodiment 8. The method according to embodiment 7, further including:
determining a bit value of the second information domain based on the target number.

Embodiment 9. The method according to embodiment 7, further including:
determining, based on a plurality of pieces of preset scheduling item information, target scheduling item information including the target number, wherein each piece of scheduling item information at least includes a number of TTIs scheduled by performing multi-TTI scheduling;
determining, based on a corresponding relationship between different numerical values and different scheduling item information, a target numerical value corresponding to the target scheduling item information; and
determining a bit value of the second information domain based on the target numerical value.

Embodiment 10. The method according to any one of embodiments 7-9, further including:
sending third signaling used for indicating that the target DCI includes the second information domain.

Embodiment 11. The method according to embodiment 1, wherein sending the first indication information used for indicating a target scheduling mode corresponding to the target DCI, includes:
sending fourth signaling used for indicating the target scheduling mode.

Embodiment 12. An information transmission method, applied to a terminal and including:
determining, in response to receiving target downlink control information (DCI) used for performing multi-transmission time interval (TTI) scheduling, a target scheduling mode corresponding to the target DCI, wherein the target scheduling mode includes a first multi-TTI scheduling mode for scheduling two or more than two identical transport blocks, or,
the target scheduling mode includes a second multi-TTI scheduling mode for scheduling two or more than two different transport blocks.

Embodiment 13. The method according to embodiment 12, wherein determining the target scheduling mode corresponding to the target DCI, includes:
determining the target scheduling mode based on the target DCI.

Embodiment 14. The method according to embodiment 13, wherein determining the target scheduling mode based on the target DCI, includes:
determining the target scheduling mode based on indication of a first information field in the target DCI.

Embodiment 15. The method according to embodiment 13, wherein determining the target scheduling mode based on the target DCI, includes:
determining, according to a corresponding relationship between different radio network temporary identifiers (RNTIs) and different scheduling mode indication information, target scheduling mode indication information corresponding to a target RNTI scrambling the target DCI; and
determining the target scheduling mode based on the target scheduling mode indication information.

Embodiment 16. The method according to embodiment 14 or 15, wherein before determining the target scheduling mode based on indication of a first information field in the target DCI, the method further includes:
configuring a terminal to support a first multi-TTI scheduling mode and a second multi-TTI scheduling mode based on first signaling sent by a base station.

Embodiment 17. The method according to embodiment 12, further including:
determining, in response to the target scheduling mode including the second multi-TTI scheduling mode, a target number of TTIs scheduled by the target DCI.

Embodiment 18. The method according to embodiment 17, wherein determining the target number of TTIs scheduled by the target DCI, includes:
determining the target number based on second signaling sent by a base station.

Embodiment 19. The method according to embodiment 18, wherein determining the target number of TTIs scheduled by the target DCI, includes:
determining the target number according to a second information domain in the target DCI.

Embodiment 20. The method according to embodiment 19, wherein determining the target number according to the second information domain in the target DCI, includes:
taking a number indicated by a bit value of the second information domain as the target number.

Embodiment 21. The method according to embodiment 19, wherein determining the target number according to the second information domain in the target DCI, includes:
determining a target numerical value indicated by the bit value of the second information domain;
determining, according to a corresponding relationship between different numerical values and different scheduling item information, target scheduling item information corresponding to the target numerical value, wherein each piece of scheduling item information at least includes a number of TTIs scheduled by performing multi-TTI scheduling; and
taking a number of the TTIs comprised in the target scheduling item information as the target number.

Embodiment 22. The method according to any one of embodiments 19-21, wherein before determining the target number according to the second information domain in the target DCI, the method further includes:

determining, based on third signaling sent by the base station, that the target DCI includes the second information domain.

Embodiment 23. The method according to embodiment 12, wherein determining a target scheduling mode corresponding to the target DCI, includes:
determining the target scheduling mode based on fourth signaling sent by a base station.

Embodiment 24. An information transmission apparatus, applied to a base station and including:
a first sending module, configured to send, in response to performing multi-transmission time interval (TTI) scheduling through target downlink control information (DCI), first indication information used for indicating a target scheduling mode corresponding to the target DCI, wherein the target scheduling mode includes a first multi-TTI scheduling mode for scheduling two or more than two identical transport blocks, or,
the target scheduling mode includes a second multi-TTI scheduling mode for scheduling two or more than two different transport blocks.

Embodiment 25. An information transmission apparatus, applied to a terminal and including:
a first determining module, configured to determine, in response to receiving target downlink control information (DCI) used for performing multi-transmission time interval (TTI) scheduling, a target scheduling mode corresponding to the target DCI, wherein the target scheduling mode includes a first multi-TTI scheduling mode for scheduling two or more than two identical transport blocks, or,
the target scheduling mode includes a second multi-TTI scheduling mode for scheduling two or more than two different transport blocks.

Embodiment 26. A computer-readable storage medium, wherein the storage medium stores a computer program, and the computer program is used for executing the information transmission method according to any one of embodiments 1-11.

Embodiment 27. A computer-readable storage medium, wherein the storage medium stores a computer program, and the computer program is used for executing the information transmission method according to any one of embodiments 12-23.

Embodiment 28. An information transmission apparatus, including:
a processor; and
a memory, configured to store processor executable instructions, wherein
the processor is configured to execute the information transmission method according to any one of embodiments 1-11.

Embodiment 29. An information transmission apparatus, including:
a processor; and
a memory, configured to store processor executable instructions, wherein
the processor is configured to execute the information transmission method according to any one of embodiments 12-23.

Other examples of the disclosure will be apparent to those skilled in the art from consideration of the specification and practice of the disclosure here. The disclosure is intended to cover any variations, uses, or adaptations of the disclosure following its general principles and including such departures from the disclosure as come within known or customary practice in the art. The specification and examples are considered as instances merely, and the true scope and spirit of the disclosure are indicated by the following claims.

It needs to be understood that the disclosure is not limited to the exact structure that has been described above and illustrated in the accompanying drawings, and various modifications and changes may be made without departing from its scope. It is intended that the scope of the disclosure is merely limited by the appended claims.

1. An information transmission method, performed by a base station and comprising:
performing multi-transmission time interval (TTI) scheduling through target downlink control information (DCI); and
sending first indication information used for indicating a target scheduling mode corresponding to the target DCI,
wherein the target scheduling mode comprises a first multi-TTI scheduling mode for scheduling two or more than two identical transport blocks or
the target scheduling mode comprises a second multi-TTI scheduling mode for scheduling two or more than two different transport blocks.

2. The information transmission method according to claim 1, further comprising:
determining the target DCI, wherein the target DCI at least comprises a first information field used for indicating the target scheduling mode; and
wherein the sending the first indication information used for indicating the target scheduling mode corresponding to the target DCI, comprises:
sending the target DCI comprising the first information field;
or, the method further comprising:
determining, according to a corresponding relationship between different radio network temporary identifiers (RNTIs) and different scheduling mode indication information, a target RNTI corresponding to the target scheduling mode; and
scrambling the target DCI through the target RNTI;
wherein the sending the first indication information used for indicating the target scheduling mode corresponding to the target DCI, comprises:
sending the target DCI scrambled through the target RNTI.

3. (canceled)

4. The information transmission method according to claim 2, the method further comprising:
sending first signaling used for configuring a terminal to support the first multi-TTI scheduling mode and the second multi-TTI scheduling mode.

5. The information transmission method according to claim 1, further comprising:
determining the target scheduling mode comprising the second multi-TTI scheduling mode, sending second indication information used for indicating a target number of TTIs scheduled by the target DCI.

6. The information transmission method according to claim 5, wherein the sending the second indication information used for indicating the target number of TTIs scheduled by the target DCI, comprises:
sending second signaling used for indicating the target number.

7. The information transmission method according to claim 5, further comprising:
determining the target DCI, wherein the target DCI at least comprises a second information field used for indicating the target number of the TTIs scheduled by the target DCI; and
sending the second indication information used for indicating the target number of the TTIs scheduled by the target DCI, comprises:
sending the target DCI comprising the second information field.

8. The information transmission method according to claim 7, further comprising:
determining a bit value of the second information field based on the target number;
or, the method further comprising:
determining, based on a plurality of pieces of preset scheduling item information, target scheduling item information comprising the target number, wherein each piece of scheduling item information at least comprises a number of TTIs scheduled by performing multi-TTI scheduling;
determining, based on a corresponding relationship between different numerical values and different scheduling item information, a target numerical value corresponding to the target scheduling item information; and
determining a bit value of the second information field based on the target numerical value.

9. (canceled)

10. The information transmission method according to claim 7, further comprising:
sending third signaling used for indicating that the target DCI comprises the second information field.

11. The information transmission method according to claim 1, wherein the sending the first indication information used for indicating a target scheduling mode corresponding to the target DCI, comprises:
sending fourth signaling used for indicating the target scheduling mode.

12. An information transmission method, performed by a terminal, the information transmission method comprising:
receiving target downlink control information (DCI) used for performing multi-transmission time interval (TTI) scheduling; and
determining a target scheduling mode corresponding to the target DCI,
wherein the target scheduling mode comprises a first multi-TTI scheduling mode for scheduling two or more than two identical transport blocks or
the target scheduling mode comprises a second multi-TTI scheduling mode for scheduling two or more than two different transport blocks.

13. The information transmission method according to claim 12, wherein the determining the target scheduling mode corresponding to the target DCI, comprises:
determining the target scheduling mode based on the target DCI.

14. The information transmission method according to claim 13, wherein the determining the target scheduling mode based on the target DCI, comprises:
determining the target scheduling mode based on indication of a first information field in the target DCI;
or, the determining the target scheduling mode based on the target DCI, comprises:
determining, according to a corresponding relationship between different radio network temporary identifiers (RNTIs) and different scheduling mode indication information, target scheduling mode indication information corresponding to a target RNTI scrambling the target DCI; and
determining the target scheduling mode based on the target scheduling mode indication information.

15. (canceled)

16. The information transmission method according to claim 14, the method further comprising:
configuring a terminal to supporting a first multi-TTI scheduling mode and a second multi-TTI scheduling mode based on first signaling sent by a base station.

17. The information transmission method according to claim 12, further comprising:
determining the target scheduling mode comprises the second multi-TTI scheduling mode, determining a target number of TTIs scheduled by the target DCI.

18. The information transmission method according to claim 17, wherein the determining the target number of TTIs scheduled by the target DCI, comprises:
determining the target number based on second signaling sent by a base station.

19. The information transmission method according to claim 18, wherein the determining the target number of TTIs scheduled by the target DCI, comprises:
determining the target number according to a second information field in the target DCI.

20. The information transmission method according to claim 19, wherein the determining the target number according to the second information field in the target DCI, comprises:
taking a number indicated by a bit value of the second information field as the target number;
or, the determining the target number according to the second information field in the target DCI, comprises:
determining a target numerical value indicated by the bit value of the second information field,
determining, according to a corresponding relationship between different numerical values and different scheduling item information, target scheduling item information corresponding to the target numerical value, wherein each piece of scheduling item information at least comprises a number of TTIs scheduled by performing multi-TTI scheduling, and
taking a number of the TTIs comprised in the target scheduling item information as the target number.

21. (canceled)

22. The information transmission method according to claim 19, the method further comprising:
determining, based on third signaling sent by the base station, that the target DCI comprises the second information field.

23. The information transmission method according to claim 12, wherein the determining a target scheduling mode corresponding to the target DCI, comprises:
determining the target scheduling mode based on fourth signaling sent by a base station.

24-27. (canceled)

28. An electronic device, comprising:
a processor; and
a memory, configured to store processor executable instructions, wherein
the processor is configured to execute the processor executable instructions, wherein the processor executable instructions cause the processor to:
perform multi-transmission time interval (TTI) scheduling through target downlink control information (DCI),
send first indication information used for indicating a target scheduling mode corresponding to the target DCI,
wherein the target scheduling mode comprises a first multi-TTI scheduling mode for scheduling two or more than two identical transport blocks or
the target scheduling mode comprises a second multi-TTI scheduling mode for scheduling two or more than two different transport blocks.

29. (canceled)
